(19) United States
(12) Patent Application Publication
(10) Pub. No.: US 2004/0024878 A1
(43) Pub. Date: Feb. 5, 2004

(54) Network device and automatic program update technique

(76) Inventors: Yoshinobu Makimoto, Fujisawa (JP); Shin?apos;ichi Sawamura, Yokohama (JP); Isao Takita, Hitachinaka (JP); Hideki Kamimaki, Fujisawa (JP)

Correspondence Address: MCDERMOTT, WILL & EMERY, 600 13th Street, N.W., Washington, DC, 20005-3096, US

(21) Appl. No.: 10/383,245

(22) Filed: Mar. 7, 2003

(30) Foreign Application Priority Data
Jul. 30, 2002 (JP) 2002-220601

(51) Int. Cl. G06F 15/173

(52) U.S. Cl. 709/226

(57) ABSTRACT

In network systems which consist of global network and local network, network device 1 is connected to the global network, and network device 3 is connected to the local network, and network device 2 is connected to both networks. When a network device 1 requests a network device 3 to update a program, a network device 2 which controls the network device 3 temporarily stores the update request and then issues the update request to the network device 3. Upon receiving the update request, the network device 3 shuts down itself and updates the program if the tasks currently running on the network device itself is not important ones. The network device 3, when turned on, also acquires the update request that has been temporarily stored by the network device 2.

### BACKGROUND OF THE INVENTION

The present invention relates to a method for updating a program of a device which is connected to a network.

In recent years, the dissemination of the Internet has enabled devices such as a PC and an ADSL modem that are connectable to networks to grow popular at homes. To correct failures or add new functions for the devices connected to those networks, it has been a recent trend that other devices connected to the network distribute programs for activating such devices via the network. Here, a program shall include firmware and an OS which activate low-level devices, middleware which runs on an OS, and various application software. Conventionally, however, it was necessary for a user to manually perform update procedures for program updating. Therefore, as a method for automatically updating firmware, for example, a method have been devised, wherein a firmware buffer is incorporated in a network device for a temporary migration of firmware, and firmware update is performed while the migrated firmware is being used from the buffer (Japanese Patent Laid-open No. 2000-172508), thus enabling to update low-level firmware.

In addition, when updating is conducted for an OS of a device connected to a network, and middleware or application software which runs on the OS, it is still necessary for a user to determine the timing to conduct an updating work. Current models of network device incorporate an HTTP server to enable the transmission of data regarding their status including the operational condition, versions of firmware, and operation menus according to external requests. A user performs an updating work by accessing a network device through an HTTP-ready browser, and selecting the program update options from the operation menu displayed on the browser. Here, the term “incorporating an HTTP server” implies a status that an application of the server which accepts a request for HTTP is in an operational condition on a network device.

### SUMMARY OF THE INVENTION

When the updating of a program of a certain network device connected to a network is carried out by controlling other devices also connected via the same network, the network device concerned is not always turned on constantly, and the program update of the network device may not be possible. In addition, if the network device is in operation, it is necessary to reboot the network device for the program to be updated. However, unconditional rebooting of other devices leads to the crash of important information available on the network device. Further, accidents such as power failure and disconnection of network may be caused at the time of updating a program of the network device, thus making the network device inoperable since the program update is not performed correctly.

The present invention features the following. A network device 1 requests a network device 2 connected to the network device 1 via a first network to update a program of a network device 3 which is connected via the foregoing network device 2 and a second network. At this time, the network device 1 sets an update level value depending on a degree of urgency of updating. The update level value is used to compare with the operation level value that is referred to later. The network device 2 has a combination list of device types of a plurality of network devices 3 and programs. Upon having a request for program update from the network device 1, the network device 2 updates or stores a program corresponding to the device type in the list, and request the network device 3 to update the program. If the network device 3 receives a request for program update from the network device 2 while the network device 3 is in operation, the network device 3 confirms the state of its own tasks currently in operation, and calculates the operation level values. Here, the operation level value is a value representing the operational status of a task and is determined depending on the operation of the task. The network device 3 compares the operation level value and the update level value, and if the update level value is larger, it judges that the degree of update urgency is higher than that of the task currently in operation. Consequently, the network device 3 shuts down itself to update the program. Note that, however, it is also possible to make a judgment that a lower update level value should represent higher degree of urgency, depending on setting conditions.

In addition, the network device 3, when turned on, requests the network device 2 to confirm the availability of program to be updated in the network device 3. The network device 2, upon receiving a program update request from the above-stated network device 3, confirms whether or not any program in the list has been updated, and if it has been updated, the network device 2 transmits a new program to the network device 3 via the second network.

Further, the network device 3 judges whether or not the device itself has been successfully activated, and if it has not been activated, it requests the network device 2 for the program.

### BRIEF DESCRIPTION OF THE DRAWINGS

FIG. 1 is a configuration diagram for the entire network;

FIG. 2 is an internal configuration diagram of a gateway device.

FIG. 3 is an internal configuration diagram of a network device;

FIG. 4 is an internal configuration diagram of a rewriting device;

FIG. 5 is a hold information diagram of EPROM included in a network device;

FIG. 6 is a program buffer diagram of a gateway device;

FIG. 7 is an internal information diagram of a program;

FIG. 8 is a program area diagram of a program stored in a nonvolatile memory of a network device;

FIG. 9 is a gateway device list available in a host;

FIG. 10 is a message diagram for a program confirmation notice used for communication between the gateway device and the rewriting device;

FIG. 11 is a message diagram for a program update notice used for communication between the gateway device and the rewriting device;

FIG. 12 is a message diagram for a program hold notice used for communication between the gateway device and the rewriting device;

FIG. 13 is a message diagram for a program request notice used for communication between the gateway device and the rewriting device;

FIG. 14 is a message diagram for boot completion signal used for communication between the rewriting device and the monitoring task;

FIG. 15 is a message diagram for program arrival signal used for communication between the rewriting device and the monitoring task;

FIG. 16 is a message diagram for program request signal used for communication between the rewriting device and the monitoring task;

FIG. 17 is a message diagram for gateway device registration request used for communication between the gateway device and the host;

FIG. 18 is a message diagram for program acquisition request used for communication among the gateway device, the host and a higher-level host;

FIG. 19 is a message diagram for program update request used for communication among the gateway device, the host and the higher-level host; and

FIG. 20 is a flow diagram showing processes in the gateway device.

### DETAILED DESCRIPTION OF THE PREFERRED EMBODIMENTS

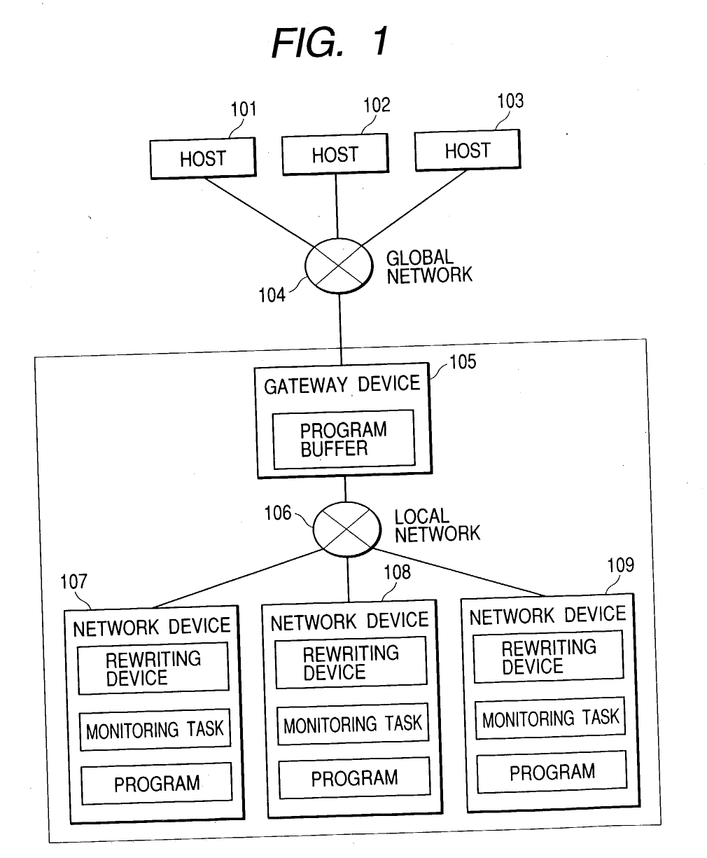

To begin with, a network configuration and an inner configuration of each device will be shown in FIGS. 1 to 8.

FIG. 1 shows a network configuration according to an embodiment according to the present invention. Reference numerals 101, 102 and 103 denote network devices which operate as a host respectively, and they are equivalent to the network device 1 stated earlier. Reference numeral 104 denotes a global network established by means of the Internet, etc. and corresponds to the first network stated earlier. Reference numeral 105 denotes a gateway device and corresponds to the network device 2 stated earlier. The gateway device 105 and hosts 101, 102 and 103 are connected to each other via the global network 104. Reference numeral 106 denotes a local network connected by means of a power line, LAN, wireless LAN, etc. and corresponds to the second network stated earlier. Reference numerals 107, 108 and 109 denote network devices set up at a home, within doors, etc. and correspond to the network device 3 stated earlier. The network devices 107, 108 and 109 as well as the gateway device 105 are connected to each other via the local network 106. Each of the network devices 107, 108 and 109 has a rewriting device 305 and a program area 801, while a monitoring task operates on such network devices. Here, a monitoring task implies a task which enables the acquisition of operation status of all tasks that run on an OS, and it can be realized in various forms by using hardware, software or their combinations. In terms of hardware, the monitoring task can be realized with any CPU, memory and other LSIs, while in terms of software, it is realizable with programs loaded into a memory.

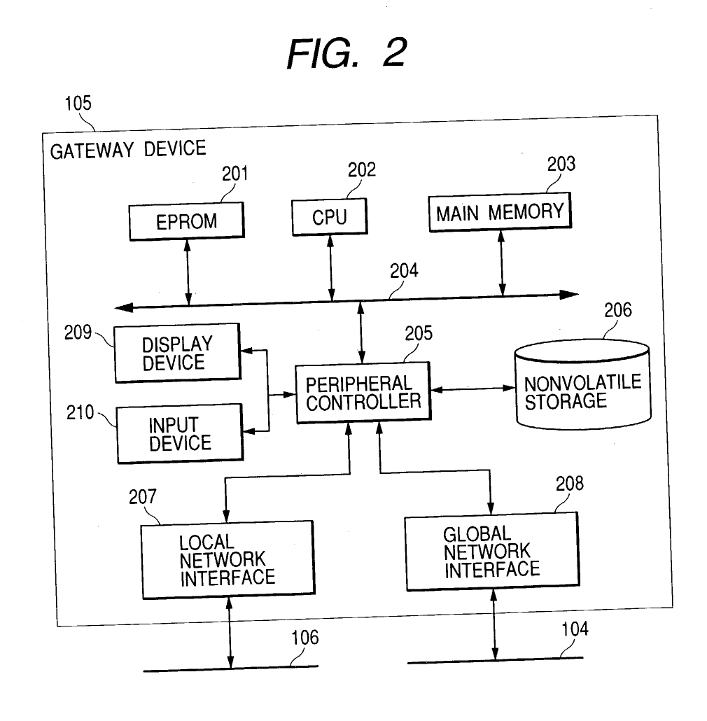

FIG. 2 shows an internal configuration diagram of the gateway device 105. Reference numeral 201 denotes a rewritable nonvolatile memory such as an EPROM to store a boot program to activate the gateway device 105. Reference numeral 202 denotes a CPU to execute processing of the entire gateway device 105. Reference numeral 203 denotes a main memory to be used as a program execution area. Reference numeral 204 denotes a bus to connect the EPROM 201, the CPU 202, the main memory 203 and a peripheral controller 205. Reference numeral 205 denotes a peripheral controller which, upon receiving a command from the main memory 203, controls a nonvolatile storage 206, a local network interface 207 and a global network interface 208 that are all coupled to the peripheral controller 205. Reference numeral 206 denotes nonvolatile storage, constitutes a data storage area to be used for programs that run on the gateway device 105 and for data to be used by such programs, and has a program buffer 601. Reference numeral 207 denotes a local network interface to connect the gateway device 105 to the local network 106. Reference numeral 208 denotes a global network interface to connect the gateway device 105 to the global network 104. Reference numeral 209 denotes a display device to display information on devices. Reference numeral 210 is an input device to accept user inputs.

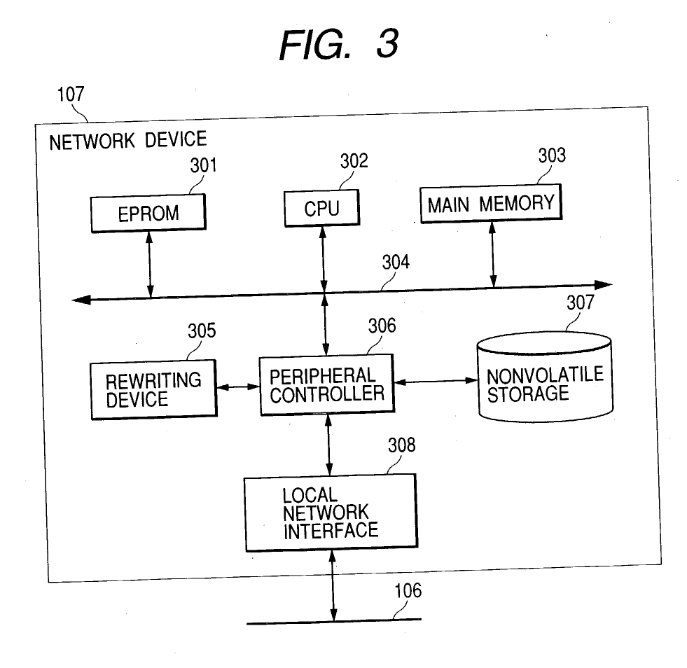

FIG. 3 shows an internal configuration diagram of the network device. Reference numeral 301 denotes a rewritable nonvolatile memory such as an EPROM, and it stores a boot program to activate the network device 107 and information on the device type of the network device 107 as well as MAC addresses of the network device 107. Reference numeral 302 denotes a CPU to execute the boot program on the EPROM 301 and programs stored in a nonvolatile storage 307. Reference numeral 303 denotes a main memory which constitutes a storage area to be used by the CPU 302 at the time of executing programs. Reference numeral 304 denotes a bus to connect the EPROM 301, the CPU 302, the main memory 303 and a peripheral controller 306. Reference numeral 305 denotes a rewriting device to update the program area 801 of the network device 107.

Reference numeral 306 denotes the peripheral controller to receive a command from the CPU 302 or the rewriting device 305 and control the nonvolatile storage 307 and a local network interface 308 which are both coupled to the peripheral controller 306. Reference numeral 307 denotes a nonvolatile storage to constitute a data storage area to be used for programs that run on the network device 107 and for data to be used by such programs, and also has the program area 801. Reference numeral 308 is a local network interface to connect the network device 107 to the local network 106. The network devices 108 and 109 are configured in the same way as the network device 107.

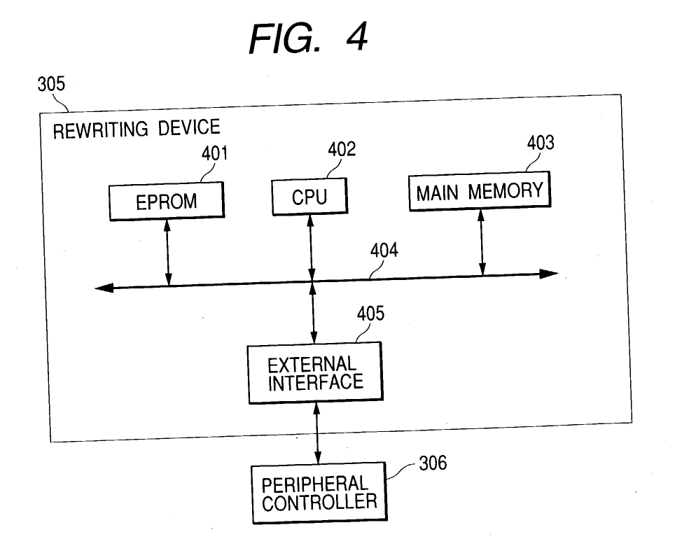

FIG. 4 shows a configuration of the rewriting device 305. Reference numeral 401 denotes a rewritable nonvolatile memory such as an EPROM, and it stores a boot program, etc. to execute operations of the rewriting device 305. Reference numeral 402 denotes a CPU to execute the boot program on the EPROM 401. Reference numeral 403 denotes a main memory and constitutes storage to be used by the CPU 402 at the time of executing a program. Reference numeral 404 is a bus to connect the EPROM 401, the CPU 402, the main memory 403 and an external interface 405. Reference numeral 405 denotes an external interface to connect the rewriting device 305 to the peripheral controller 306.

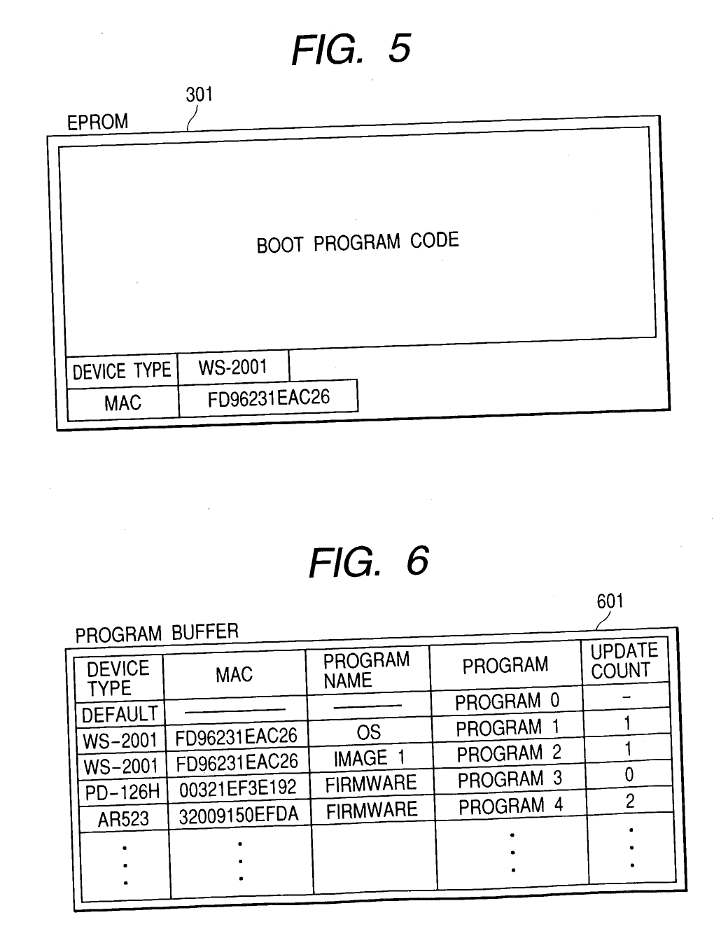

FIG. 5 shows information to be stored on the EPROM 301. Boot program code of the network device 107, device type of the network device 107, and MAC address of the device 107 are all available on the EPROM 301.

FIG. 6 shows a configuration of the program buffer 601 located in the gateway device. Each entry of the program buffer comprises the device type of a network device, an MAC address which uniquely indicates the network device on a local network, a program name, a program, and a set of update counts.

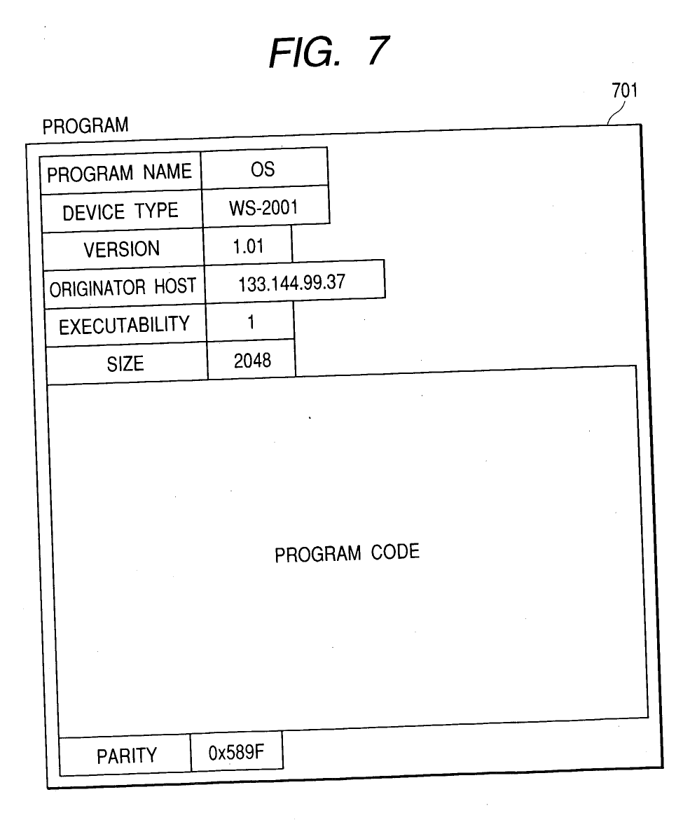

FIG. 7 shows an internal configuration of a program 701. The program 701 comprises device types of a plurality of network devices which can utilize the program, program version, originator host which is the address of host from which the program has been acquired, an executability flag to show if the program can be automatically executed, a program size, program code and parity information of the program. The program code may include a firmware program to activate the nonvolatile storage 307, a firmware program to activate the local network interface 308, the OS program, and a middleware and/or an application program which run on the OS. In addition, the program may include information on various contents such as voices, images and video image data. For example, when the program include a firmware program, the executability flag should be 1 (independent execution is possible), and when the program data includes content data and such data that is utilized by other applications, the executability flag should be 0 (independent execution is not possible). The parity is a value which is calculated with a specified method from a string of program code.

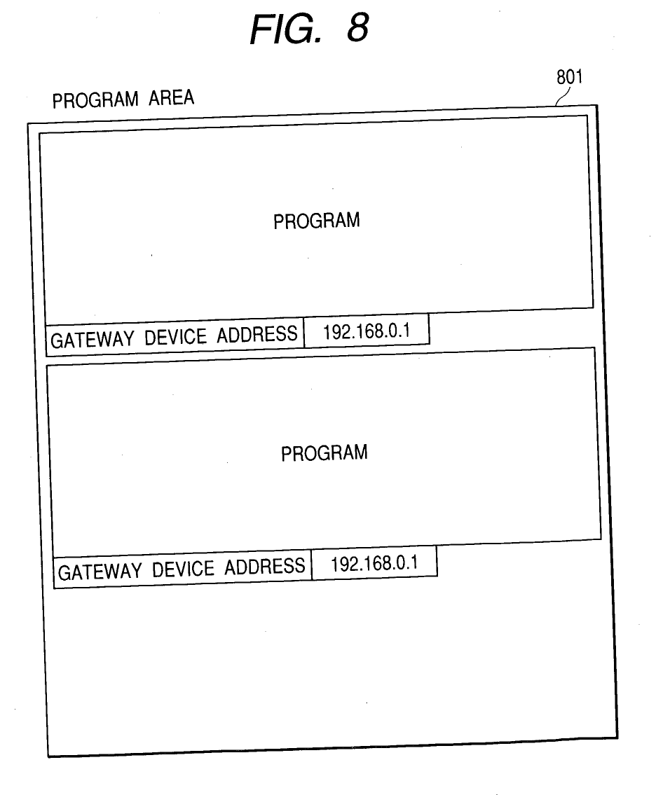

FIG. 8 shows a configuration of the program area 801 to be secured in the nonvolatile storage 307. The program area 801 comprises a plurality of programs 701 and the address of the gateway device 105 on the local network 106.

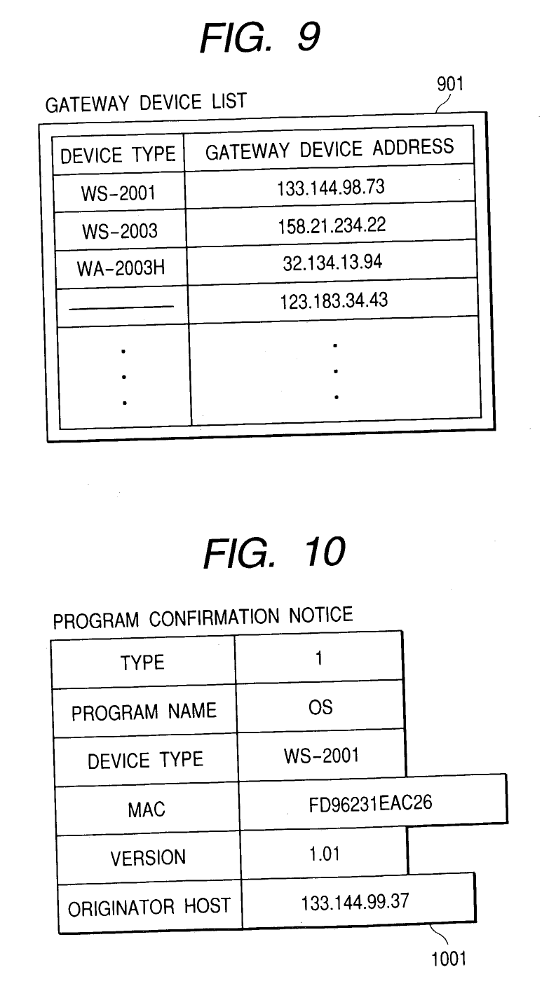

FIG. 9 shows a gateway device list 901 which is included in the hosts 101, 102 and 103, respectively. The gateway device list 901 comprises sets of the device types of a network device located on the local network 106 and addresses of gateway devices connecting the local network 106 and the global network 104.

Next, communication messages between the gateway device 105 and the rewriting device 305 will be shown in FIGS. 10 to 13. Communication between the gateway device 105 and the rewriting device 305 is executed by utilizing a specified port for TCP(UDP)/IP, or for other protocols, by adding and identifying a specified header. Each message is provided with a type number indicating the type of the message.

FIG. 10 shows a program confirmation notice. A program confirmation notice 1001 includes a type showing that the notice is a confirmation, a device type of network device, an MAC address, a program version, and an originator host which is the address of a host from which the program has been acquired. The program confirmation notice 1001 is issued by the rewriting device 305 of the network device to the gateway device 105, and the notice constitutes a program confirmation request to the gateway device 105.

FIG. 11 shows a program update notice. A program update notice 1101 includes a type number showing the notice is an update, an update level and a program. The program update notice 1101 is issued by the gateway device 105 to the rewriting device 305 of the network device, and the notice constitutes a program update request to the network device.

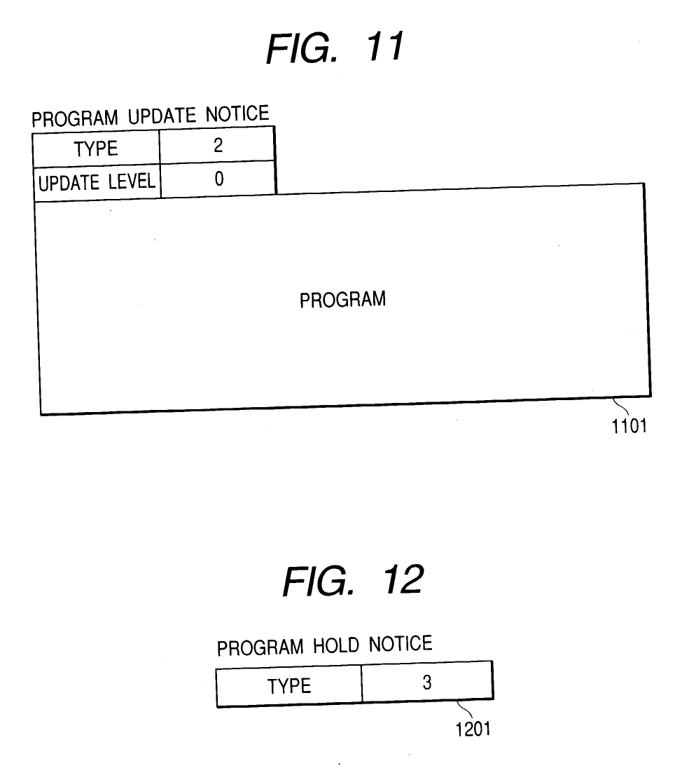

FIG. 12 shows a program hold notice. A program hold notice 1201 includes a type number showing that the program is to be held.

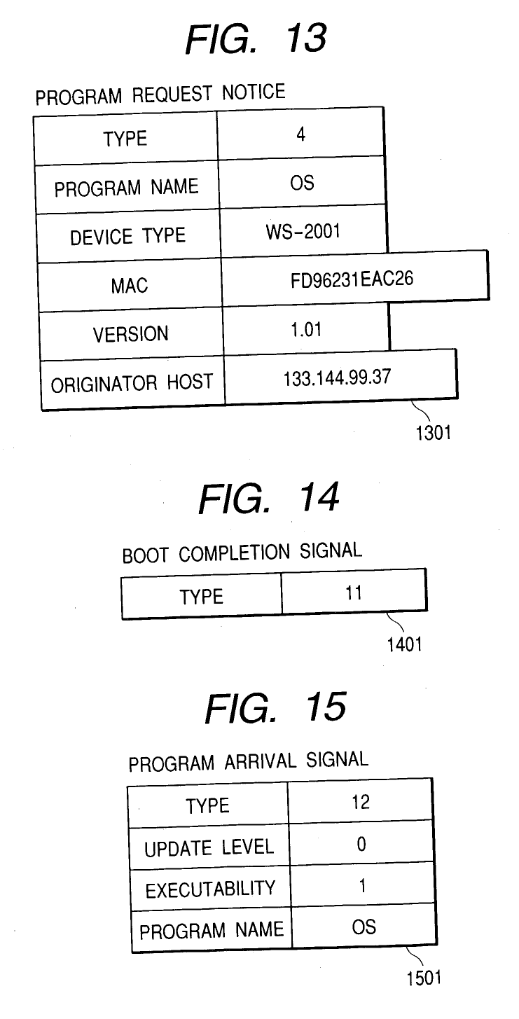

FIG. 13 shows a program request notice. A program request notice 1301 includes a type number showing the notice is a request, a device type of a network, an MAC address, a program version, and an originator host which is the address of a host from which the program has been acquired.

Next, FIGS. 14 to 16 show communication messages between the rewriting device 305 and a monitoring task. The rewriting device 305 and the monitoring task execute communication by writing information to a specified address of the nonvolatile storage 307, or by generating an interruption to the CPU 302 and the CPU 402. Each message is provided with a type number indicating the type of the message.

FIG. 14 shows a boot completion signal. The boot completion signal 1401 includes a type number showing that the booting has been completed.

FIG. 15 shows a program arrival signal. The program arrival signal 1501 includes a type number showing that the program has arrived and an update level.

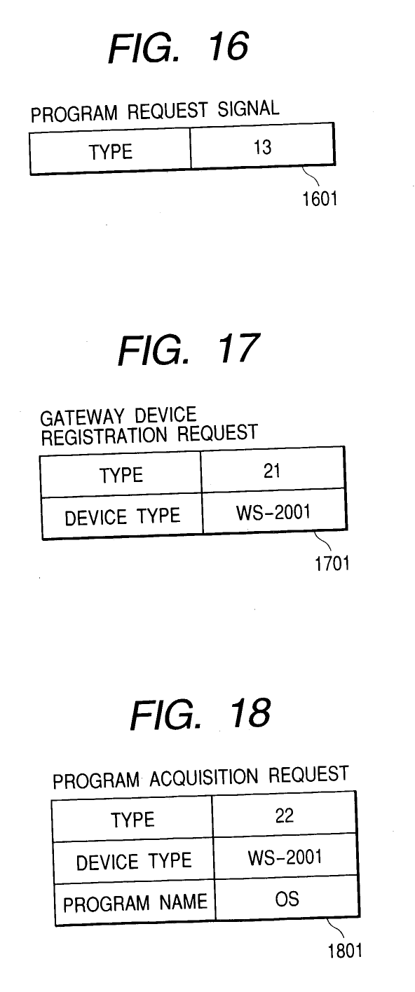

FIG. 16 shows a program request signal. The program request signal 1601 includes a type number showing that the signal is for a request.

Next, FIGS. 17 to 19 show communication messages between the gateway device 105 and the hosts 101, 102 and 103. The gateway device 105 and the hosts 101, 102 and 103 executes communication by utilizing a specified port for TCP (UDP)/IP. Each message is provided with a type number indicating the type of the message.

FIG. 17 shows a gateway device registration request. A gateway device registration request 1701 includes a type number showing a registration and a device type of a network device to be registered.

FIG. 18 shows a program acquisition request. A program acquisition request 1801 includes a type number showing an acquisition, a device type of a network device requesting for program acquisition, and a program name.

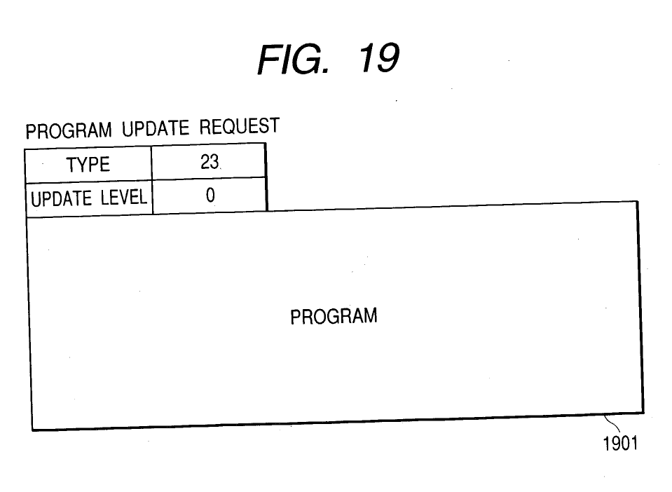

FIG. 19 shows a program update request. A program update request 1901 includes a type number showing an update, an update level and a program.

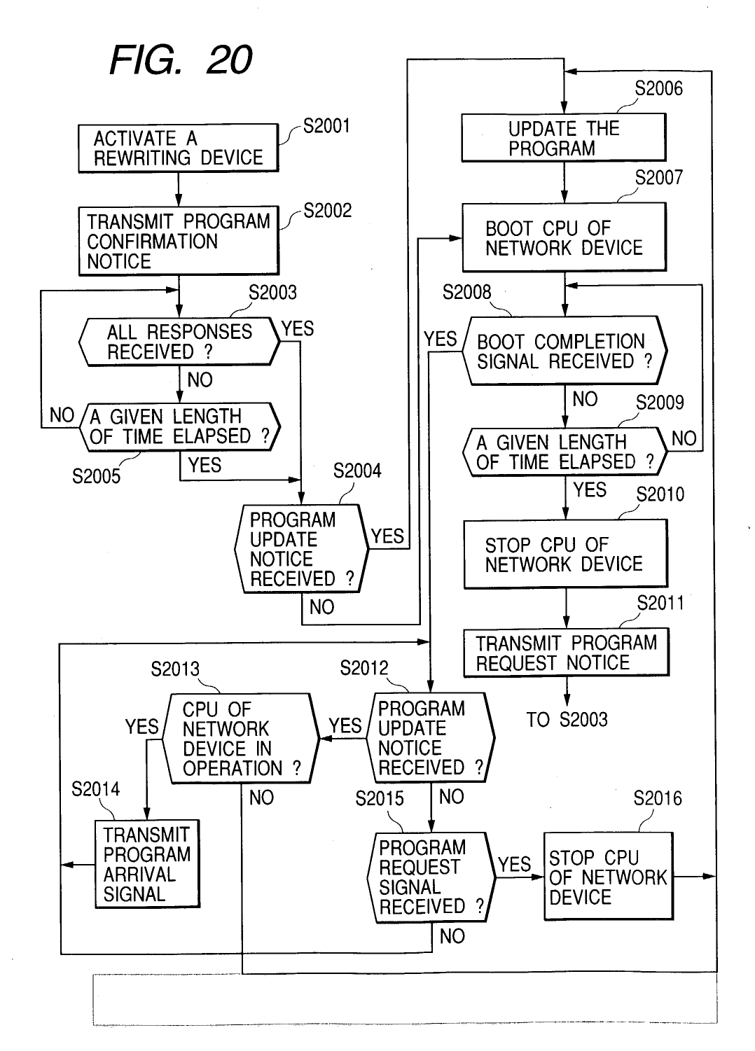

FIG. 20 is a flow chart showing a series of operation of the rewriting device 305, and reference symbols S2001 to S2016 indicate respective operations of the rewriting device 305.

Hereinafter, a first embodiment of the present invention will be described.

To begin with, the configuration of a network device and the outline of its operations will be described. The hosts 101, 102 and 103 illustrated in FIG. 1 are configured in the same way as a typical personal computer (PC) and each has a list of programs associated with the device type of respective network device and the gateway device list 901. The host monitors the program list, and when a program is updated, the host transmits the program to a gateway device registered in the gateway device list 901.

The network device 107 illustrated in FIG. 1 is provided with the rewriting device 305 and also has the program area 801 in the nonvolatile storage 307. Here, it should be noted that the rewriting device 305 may be installed outside the network device instead of being incorporated in the network device. When the network device 107 is booted, first, the rewriting device 305 confirms if any program in the program area 801 should be updated, and then a program in the program area 801 is executed by the boot program in the EPROM 301. The program in the program area 801 boots the OS, and then respective application tasks and the monitoring task to acquire the status of such application tasks are executed. In the event that the monitoring task will not be initiated for a given period of time, the rewriting device 305 transmits a program request to the gateway device via the local network interface 308.

In addition, when a request for program update comes from the gateway device via the local network interface 308, the monitoring task acquires the status of each application task, and if the monitoring task judges based on such status that the program can be updated, the monitoring task quits respective applications, shuts down the CPU 302, rewrites the program in the program area 801, and re-boots the network device 107.

Next, the outline of components and operations of the gateway device 105 will be described by referring to FIG. 1. The gateway device 105 has the program buffer 601 in the nonvolatile storage 206, and upon receiving a request for a program from a network device via the local network interface 207, confirms if a corresponding program exists in the program buffer 601. If the program is available, the gateway device 105 transmits the program via the local network interface 207. If not, however, the gateway device 105 requests the program to the host via the global network interface 208.

In addition, the gateway device 105 may be configured so as to supply it with power separate from the network device 107, 108 or 109. In this configuration, the gateway device 105 can acquire and store programs independent of the power-supply condition of the network device 107, 108 or 109.

On the other hand, when the gateway device receives a program update request from the global network interface 208, the gateway device confirms if the device type of the network device has been registered in the program buffer. If the device type is registered, the gateway device overwrites the corresponding program, and transmits the program to the network device corresponding to the above-stated device type via the local network interface 207. At this time, a display device 209 displays the name and the version of the updated program together with the device type of a device to execute the program as well as other information. In addition, also when a user issues a request to display the program via the input device 210, the display device 209 displays the name and the version of the program as well as other information. Here, it should be noted that the device type implies the device type of a network device and is a parameter to judge characteristics of the network device. With the first embodiment, the device type of a network device is chosen to judge if the network device is capable of executing the program to be transmitted from the host. However, any other parameters may alternatively be used if they are information showing characteristics of a network device. Further, when the gateway device 105 does not have a display device, but a network device has a display device instead, it may be so arranged that the gateway device 105 transmits information on display contents to the network device for the display on the display device of the network device.

Next, means for realizing an automatic program update technique will be described by referring to operations of respective devices at the time of updating a program.

When a program for a network device is updated on the host 101, the host 101 searches for the device type of the network device in the updated program out of the gateway device list 901, and then searches for a corresponding gateway device. The host 101 sets the update level and the updated program in the program update request 1901, and transmits them to respective gateway devices that have been found through the search. Here, the update level shall imply a value showing a degree of the update urgency of a program, and the level with larger value shall have higher urgency. Also, the update level shall be a reference to judge that the program can be aborted to rewrite the program if the operation level of a network device is smaller than the value of the update level, and the level shall be set manually.

When the gateway device 105 receives the program update request 1901, it acquires the device type, the update level and a program from the program update request 1901. Subsequently, the gateway device 105 acquires an MAC address from the program buffer 601, with the device type being an index. The gateway device 105 sets the update level and the program in the program update notice 1101, and transmits it to a rewriting device of the network device having the MAC address acquired from the program buffer 601. In addition, the gateway device 105 updates a program corresponding to the device type and the program name available in the program buffer. If the device type is available, but the corresponding program name is not available, the gateway device registers it anew.

When the rewriting device 305 receives the program update notice 1101 (S2012), it confirms if the CPU 302 is in a shutdown (S2013), and if the CPU 302 is in a shutdown, the rewriting device performs processing of S2006 and subsequent processing which will be referred to later. If the CPU 302 is in operation, the rewriting device sets the update level, the executability flag and the program name in the program arrival signal 1501, and transmits the signal to the monitoring task (S2014).

When the monitoring task receives the program arrival signal 1501, it confirms operation status of each task, and calculates an operation level. The reference value of the operation level shall be zero (0), and the value shall increase depending on the status of the task. The status of tasks includes ‘task in operation’, ‘task on standby’, ‘task in suspension’ and ‘task in shutdown’, and the increment value of each status shall be able to be set by a user at the time of initiating the task or while the task is in operation. For example, the operation level 3 is set when a task is in operation, the level 2 is for a task on standby, and the level 1 is for a task in suspension, and the level 0 is for the task in shutdown. The monitoring task stores the ID of each task and the increment value according to the status of the task. In addition, a plurality of related tasks may be grouped as a task group.

After the monitoring task has calculated the operation level of each task available in each task group, if the executability flag is 1, then the monitoring task compares the operation level of the task showing the highest value among tasks available in each task group with the update level of the program arrival signal 1501. When the update level is higher, the monitoring task shuts down each task and the operation of the CPU 302, and transmits the program request signal 1601 to the rewriting device 305. If the executability flag is zero (0), the monitoring task compares the operation level of each task available in a task group corresponding to the program name with the update level. When the update level is higher, the monitoring task shuts down the corresponding task, and transmits the program request signal 1601 to the rewriting device 305. In either case that the executability flag is 0 or 1, when the update level is the same as the operation level or the operation level is higher, the monitoring task subsequently repeats confirming the operation level of each task at regular time intervals. When the maximum value of the operation level falls below the update level, the monitoring task transmits the program request signal 1601 to the rewriting device 305.

When the rewriting device 305 receives the program request signal 1601 from a monitoring task (S2015), if the executability flag is 1, it shuts down the CPU 302 (S2016), overwrites the program of the nonvolatile storage 307 with a new program (S2006), and resets the CPU 302 (S2007). Subsequently, the rewriting device 305 executes processes of S2008 and subsequent processing which will be referred to later.

Hereinafter, means for realizing an automatic program update technique will be described while referring to operations of each part when the network device 107 connected to the local network 106 is initiated.

When the network device 107 is turned on, the rewriting device 305 is booted (S2001). The rewriting device 305 executes a boot program on the EPROM 301. As directed by the boot program, the rewriting device 305 reads a device type and an MAC address from the EPROM 301, and reads a version, an originator host and a gateway device address from a program in the program area 801 of the nonvolatile storage 307. Thereafter, the rewriting device 305 sets the device type, the MAC address, the version, and the originator host thus read out to the program confirmation notice 1001. Further, the rewriting device 305 acquires the program name of a program whose executability flag is 1 out of a plurality of programs that are registered in the program area 801, sets the program name to the program confirmation notice 1001, and transmits the name to the gateway device 105 (S2002). When no gateway device address is set, the rewriting device executes broadcasting.

When the gateway device 105 receives the program confirmation notice 1001, the gateway device 105 reads a corresponding program, using a set of the device type, the MAC address and the program name in the program confirmation notice 1001 as an index. The gateway device 105 compares the program version that has been read with the version in the program confirmation notice 1001, and if the program version thus read out is newer, the gateway device sets a new program to the program update notice 1101 and zero (0) to the update level, and transmits it to the rewriting device 305. The update level will be referred to later.

When no corresponding set of the device type and the MAC address is available in the program buffer 601, the gateway device 105 registers the device type and the MAC address anew to the program buffer 601, sets the device type to the gateway device registration request 1701, and transmits it to the host in the program confirmation notice 1001. Then, the gateway device transmits the program hold notice 1201 to the rewriting device 305. Also, for either case that the program version in the program buffer 601 is the same or older, the gateway device 105 transmits the program hold notice 1201 to the rewriting device 305.

When the host 101 receives the gateway device registration request 1701, it registers a set of an address of the gateway device 105 and a device type in the gateway device registration request 1701 to the gateway device list 901. Then, the host 101 sets the program corresponding to the device type to the program update request 1901, sets the update level to zero (0), and transmits them to the gateway device 105.

When the gateway device 105 receives the program update request 1901, it reads a device type of a network device out of the program available in the program update request 1901, overwrites the program corresponding to the device type of the program buffer 601, sets the program to the program update request notice, sets the update level to zero (0) in the notice, and transmits the notice to the network device corresponding to the device type.

Since the rewriting device 305 has transmitted a plurality of program confirmation notices 1001, it waits for responses on all transmitted notices (S2003), or enters the wait status for a given length of time elapsed (S2005). Here, the response implies either the program update notice 1101 or the program hold notice 1201. When the rewriting device 305 had executed the confirmation of received notice (S2004) and received the program update notice 1101, the rewriting device writes the program in the program update notice 1101 over an area corresponding to the program name in the program area 801 (S2006), overwrites the address of the gateway device which has transmitted the program update notice 1101 on the program area 801, and resets the CPU 302 (S2007). The rewriting device 305 checks the parity in advance when it writes the program.

In the event that all notices received by the rewriting device 305 are program hold notices 1201, the rewriting device resets the CPU 302 (S2007). When the rewriting device receives no response from the gateway device 105 for a given period of time after transmitting the program confirmation notice 1001 (S2005), it resets the CPU 302 (S2007). Thereafter, the rewriting device 305 enters in the wait state for the boot completion signal 1401.

When the CPU 302 is booted, it starts up the OS in compliance with the boot program on the EPROM 301, and confirms that the local network interface 308 and the nonvolatile storage 307 function normally. The OS starts up applications and the monitoring task. It then transmits the boot completion signal 1401 to the rewriting device 305. At this time, the reception of the boot completion signal 1401 by the rewriting device 305 (S2008) completes the startup of the network device 107 to establish the wait state for communication.

In the event that starting up of the OS fails, or the normal functioning of the local network interface 308 or the nonvolatile storage 307 cannot be confirmed, the boot completion signal 1401 will not be transmitted. After the rewriting device 305 has started up the CPU 302, if it does not receive the boot completion signal 1401 for a given period of time (S2009), the rewriting device 305 judges that any problem has occurred in a program, shuts down the CPU 302 (S2010) and transmits the program request notice 1301 to the gateway device 105 (S2011). Then, the rewriting device 305 executes processes of S2003 and subsequent processing.

When the gateway device 105 receives the program request notice 1301, it reads a program and the update count corresponding to a set of the device type of the network device and the MAC address available in the program request notice 1301. If the update count is below a given value, the gateway device 105 sets the update level to zero (0) and transmits the program update notice 1101 to the rewriting device 305 to increment the update count. When the update count is the given value or larger, the gateway device judges that the program is invalid, and it reads the originator host from the program request notice 1301, sets the device type of the network device to the program acquisition request 1801, and transmits the request to the host 101.

When the host 101 receives the program acquisition request 1801, it reads the device type of the network device in the program acquisition request 1801, sets the program corresponding to the device type of the network device and the update level “zero (0)” to the program update request 1901, and transmits the request to the gateway device 105.

When the gateway device 105 receives the program update request 1901, it acquires the device type of the network device, the update level and the program from the program update request 1901, overwrites the program corresponding to the device type of the network device in the program buffer 601, and sets the update count to zero (0). Thereafter, the gateway device 105 sets the update level thus acquired to a program update notice 1101 and transmits the notice to the rewriting device of the network device corresponding to the program.

Hereinafter, a second embodiment will be described.

A host 101 has a program corresponding to the device type of respective network devices and a host list. The host list is a list of host addresses to which the update of a program should be notified. In the second embodiment, the host list of the host 101 has the address of a host 103. The host 103 has a higher-level host list, a program backup list, and a gateway device list. The higher-level host list is a list of hosts which distribute programs. The program backup list is a list of combination sets each consisting of a device type of network device and program corresponding to the device type. The gateway device list is a list of addresses of gateway devices to which the host 103 should notify program updates. A program buffer 601 of a gateway device 305 may have a “default” for the device type field of a network device. A program associated with the “default” entry has no program code, but has address information of the host 103 instead as an originator host.

With the second embodiment, the host 101 and the host 102 shall be higher-level hosts which distribute programs, and the host 103 shall be a host which administrates the gateway device.

The way of processing the communication between the gateway device 105 and the rewriting device 305, and the communication between the rewriting device 305 and the monitoring task are the same as the first embodiment.

Hereinafter, operations of the gateway device 105 and the host 103 when the gateway device 105 receives a program confirmation notice 1001 from the rewriting device 305 will be described.

Principally, the way of processing to be executed when the gateway device 105 receives the program confirmation notice 1001 is similar to the first embodiment, except the case where a set of the device type of a network device and an MAC address that are obtained from the program confirmation notice 1001 does not exist in a program buffer 601. The processing in that case will be executed in the following way. The gateway device 105 acquires a host address from the program field associated with the “default” entry of the program buffer, and transmits a gateway device registration request 1701 in which the device type of a network device 107 is set to the host concerned. At this time, the transmission may be executed with the field of the device type of the network device in the gateway device registration request 1701 left blank. Making the field of the device type of the network device in the gateway device registration request 1701 blank enables hiding of which network device is connected to a local network 106.

When the host 103 receives the gateway device registration request 1701 from the gateway device 105, it reads the device type of the network device from the gateway registration request 1701, and registers a set of a device type of the network device and an address of the gateway device to the gateway device list 901. If the device type field of the network device is not left blank, the host 103 reads a program corresponding to the device type of the network device from the program backup, sets the program and the update level zero (0) to a program update request 1901, and transmits the request to the gateway device 105.

Next, operations of the gateway device 105 as well as the hosts 103 and 102 when the gateway device 105 receives a program request notice 1301 from the rewriting device 305 will be described.

When the gateway device 105 receives the program request notice 1301, it reads a device type of a network device from the program request notice 1301, sets the device type of the network device in a program acquisition request 1801, and transmits the request to the host which is acquired from the program field associated with the “default” entry of the program buffer 601. Thereafter, the gateway device 105 enters in the wait state for the program update request 1901. Subsequently, when the gateway device 105 receives the program update request 1901, it sets the program and the update level zero (0) in the program update request 1901, and transmits the request to the rewriting device 305.

When the host 103 receives a program acquisition request 1801, it reads a device type of a network device from the program acquisition request 1801, and acquires the program corresponding to the device type of the network device from a program backup. If any program corresponding to the device type of the network device does not exist, the host 103 transmits the program acquisition request 1801 to a host available in a list of higher-level hosts. Thereafter, the host 103 is put in the wait state for the program update request 1901. When the host 103 receives the program update request 1901, it transmits the request to the gateway device 105. Operations of the host 102 are similar to those of the host 101 referred to in the description of the first embodiment.

Next, operations of the host 102, the host 103 and the gateway device 105, when a program is updated, will be described.

When a program is updated by a user, he or she registers an appropriate update level and an updated program in the host 102. Upon the registration of an updated program, the host 102 sets the update level and registered program in the program update request 1901. Then, the host 102 transmits the program update request 1901 concerned respectively to the hosts registered in the host list.

When the host 103 receives the program update request 1901, it reads the device type of a network device from the program in the program update request 1901, and stores a set of the device type of the network device and the program in the program backup. Then, the host 103 acquires the gateway device addresses corresponding to the device types of the network devices read out of the gateway device list 901, and transmits the program update request 1901 to each gateway device. Also, the host 103 transmits the program update request 1901 to each gateway device whose device type field is registered blank.

When the gateway device 105 receives the program update request 1901, it reads a device type of a network device from the program in the program update request 1901. Then, the gateway device 105 acquires an MAC address of the network device corresponding to the device type of the network device read out of the program buffer 601, and transmits the program update notice 1101 to each network device. If no MAC address of the network device corresponding to the device type of the network device exists, the gateway device neglects the program update request 1901.

Next, as a third embodiment, a case where the gateway device 105 does not have a program buffer will be described by referring to the first and the second embodiment.

Operations of the hosts and network devices are similar to those stated in the first and the second embodiment. Hereinafter, operations of the gateway device 105 will be described.

When the gateway device 105 receives either the program confirmation notice 1001 or the program request notice 1301 from the rewriting device 305, it reads a program name, device type of a network device and an originator host from the notice it received, sets the device type of the network and the program name in the program acquisition request 1801 and transmits the request to the originator host. At this time, if the notice thus received is the program confirmation notice 1001, the gateway device 105 stores the notice temporarily.

When the gateway device 105 receives the program update request 1901, if it finds that the program confirmation notice 1001 is stored, it compares the device type, the program name and the version of the program confirmation notice 1001 with the device type of the network device, the program name and the version in the program update request 1901.

In the event that the device type of the network device and the program name coincide, and the version contained in the program update request 1901 is new, the gateway device 105 transmits the program update notice 1101 to the network device corresponding to the device type of the network device, and discards the program confirmation notice 1001 that has been temporarily stored by the gateway device itself. When the device type of the network device and the program name coincide, and the version contained in the program update request 1901 is the same or old, the gateway device 105 transmits the program hold notice 1201 to the network device corresponding to the device type of the network device, and discards the program confirmation notice 1001 that is temporarily stored by the gateway device itself. Further, if the device type of the network device and the program name does not coincide, the gateway device 105 transmits the program update notice 1101 to the network device corresponding to the device type of the network device.

While the invention has been described in its preferred embodiments, it is to be understood that the words which have been used are words of description rather than limitation and that changes within the purview of the appended claims may be made without departing from the true scope and spirit of the invention in its broader aspects.

According to the present invention, the distribution and the automatic update of a program become feasible, whether or not a network device is in operation or is under suspension. In addition, in the event that an update of a program fails, it is possible to automatically restore the program. Further, at the time of performing an update, it is possible for an application designer to set conditions for suspending an application, thus enabling safe suspension and reactivation.

In addition, the network devices can acquire programs that the gateway device has preserved through a well-stabilized local network, instead of acquiring them directly through poorly stabilized global network. That enables the network devices to update programs in secured situations.

What is claimed is:

1. A network system comprising:
a first network;
a second network;
a first network device connected to said first network;
a second network device connected to said first network and said second network; and
a third network device connected to said second network;
wherein said second network device includes:
first input and output means for receiving a program which is transmitted by said first network device via said first network;
storage means for storing said program;
means for updating a program, which is pre-installed in said second network device, corresponding to the program received from said first network device;
a table for associating said program received with information showing said third network device; and
second input and output means for transmitting said program updated, via said second network, to said third network device identified by said table.

2. The network system according to claim 1, wherein said second network device transmits to said third network device, after receiving the program from said first network device, an update request for a program owned by said third network device.

3. The network system according to claim 1, wherein said third network device transmits to said second network device, at the time of activation, an update confirmation request for a program owned by said third network device itself.

4. The network system according to claim 3, wherein, when said second network device has, at the time of receiving said update confirmation request, said updated program corresponding to information showing said third network device, said second network device transmits said updated program to said third network device.

5. The network system according to claim 3, wherein, when said second network device does not have, at the time of receiving said update confirmation request, said updated program corresponding to information showing said third network device, said second network device requests said first network device to transmit the program identified by said update confirmation request.

6. The network system according to claim 3, wherein, if any failure happens in said third network device, said second network device transmits a transmission request for said program to said first network device.

7. The network system according to claim 1, wherein, said first network device includes:
storage means for storing said program;
means for transmitting said program; and
storing means for storing said program and a list of addresses of said second network device to which said program is to be transmitted;
wherein said first network device transmits said program to said second network device, if any change is made to said program, or when said first network device receives a request for program transmission from said second network device.

8. The network system according to claim 1, wherein, said first network device transmits to said second network device said program and an update level value showing a degree of urgency of the program updating.

9. The network system according to claim 1, wherein, said third network device includes:
means for receiving said program via said second network;
means for storing said program;
judgment means for judging whether or not said program should be updated; and
means for rewriting said program.

10. The network system according to claim 9, wherein, said judgment means compares an update level value showing a degree of urgency of updating said program transmitted by said second network device with an operation level value showing the operation level of said third network device, and judges that a program should be updated when said update level value is larger than said operation level.

11. The network system according to claim 1, wherein, said third network device includes:
means for confirming the activation status of the third network device itself; and
means for transmitting a program request to said second network device when the third network device itself cannot be activated.

12. A network device connected to a first and a second network, said network device comprising:
first input and output means for receiving a program transmitted by a first network device connected to said first network;
storage means for storing said program;
means for updating a program, which is pre-installed in said network device, corresponding to the program received from said first network device;
a table for associating said program received with information showing a second network device connected to said second network; and
second input and output means for transmitting said program updated via said second network to said second network device identified by said table.

13. The network device according to claim 12, wherein, said network device transmits to the second network device, after receiving the program from said first network device, an update request for a program owned by said second network device.

14. The network device according to claim 13, wherein, when an update confirmation request is received from said second network device, if said network device has the updated program, which is received from said first network device, corresponding to information showing said second network device, said network device transmits said updated program to said second network device.

15. The network device according to claim 12, wherein, when an update confirmation request is received, if said network device does not have the updated program, which is received from said first network device, corresponding to information showing said second network device, said network device requests said first network device to transmit a program identified by said update confirmation request.

16. In a network system having a first network; a second network; a first network device connected to said first network and said second network; and a second network device connected to said second network, a network device connected to said first network comprising:
means for storing a program;
means for transmitting said program; and
storage means for storing said program and a list of addresses of said first network device(s) to which said program is transmitted;
wherein said network device transmits said program to said first network device, if any change is made to said program, or when said network device receives a program transmission request from said first network device.

17. The network device according to claim 16, wherein, said network device transmits said program and an update level value showing a degree of urgency of the program updating to said second network device via said first and second networks.

18. In a network system having a first network; a second network; a first network device connected to said first network; and a second network device connected to said first network and said second network, a network device connected to said second network comprising:
means for receiving a program via said second network;
storage means for storing a program;
judgment means for judging whether nor not said program contained in said storage means should be updated by said program received; and
means for rewriting said program contained in said storage means by said program received.

19. The network device according to claim 18, wherein, said judgment means compares an update level value showing a degree of urgency of updating said program transmitted by said first network device with the operation level value showing the operation level of the network device itself, and when said update level value is larger than said operation level value, said judgment means judges that said program contained in said storage means should be updated.

20. The network device according to claim 18, further comprising:
means for confirming the activation status of the network device itself; and
means for transmitting a program update confirmation request to said second network device when the network device itself cannot be activated.

21. The network device according to claim 18, wherein, if any failure occurs in the network device itself, said network device transmits a transmission request for said program to said second network device.
